(19) United States
(12) Patent Application Publication
(10) Pub. No.: US 2026/0317069 A1
(43) Pub. Date: Oct. 15, 2026

(54) ELIMINATING FORMATION OF BUILDUPS IN A CONVEYOR

(71) Applicant: UPM-KYMMENE CORPORATION, Helsinki (FI)

(72) Inventors: Vilho NISSINEN, Helsinki (FI); Juha TAMPER, Helsinki (FI); Moritz LESCHINSKY, Helsinki (FI); Gerd UNKELBACH, Helsinki (FI); Isko KAJANTO, Helsinki (FI); Mauno MIETTINEN, Helsinki (FI); Sami TURUNEN, Helsinki (FI); Marina STÅHL, Helsinki (FI)

(21) Appl. No.: 19/120,037

(22) PCT Filed: Oct. 12, 2023
(86) PCT No.: PCT/FI2023/050581

§ 371 Date: Apr. 10, 2025

(30) Foreign Application Priority Data
Oct. 14, 2022 (FI) 20225938

(51) Int. Cl. B65G 33/14; B65G 33/26; B65G 45/00; B65G 45/22

(52) U.S. Cl. CPC B65G 33/14; B65G 33/26; B65G 45/005; B65G 45/22; B65G 2201/042

(57) ABSTRACT

A conveyor for pretreated biomass includes a cylindrical shell having an inlet for receiving the pretreated biomass and an outlet whereat the pretreated biomass passes out of the cylindrical shell. and The at least one conveyor screw is rotatably positioned in the cylindrical shell to move the pretreated biomass out of the cylindrical shell. A temperature inside the cylindrical shell is from 120 °C to 250 °C. The at least one conveyor screw and/or the cylindrical shell is configured to be at least partly coated with a coating material and/or polished. Also a system, use, and a method is disclosed.

### FIELD OF THE INVENTION

The present application relates generally to a conveyor. More specifically, the present application relates to eliminating formation of buildups in the conveyor.

### BACKGROUND OF THE INVENTION

Conveyors are used to transfer pretreated biomass from one process to another. A conveyor comprises a shafted conveyor screw to move the pretreated biomass from an inlet of the conveyor to an outlet. However, especially at high temperatures buildups may be formed on a surface of the shafted conveyor screw, which may require regular cleaning. It is important to find solutions wherein forming of the buildups could be avoided.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. The scope of protection sought for various embodiments of the present disclosure is set out by the independent claims.

The embodiments of the present disclosure provide a conveyor for pretreated biomass comprising a cylindrical shell and at least one conveyor screw. The at least one conveyor screw and/or the cylindrical shell may be at least partly coated and/or polished, which may prevent forming of the buildups inside the conveyor. This way the conveyor screw and the cylindrical shell may stay cleaner and if cleaning is needed it may also be easier.

According to a first aspect a conveyor for pretreated biomass is disclosed. The conveyor may comprise: a cylindrical shell that may comprise an inlet for receiving the pretreated biomass and an outlet whereat the pretreated biomass passes out of the cylindrical shell; and at least one conveyor screw rotatably positioned in the cylindrical shell to move the pretreated biomass out of the cylindrical shell, wherein a temperature of the biomass inside the cylindrical shell may be from 120 °C to 250 °C; and the at least one conveyor screw and/or the cylindrical shell may be configured to be at least partly coated with a coating material and/or at least partly polished.

If the pretreatment conditions are severe or the pretreated biomass stream is not moving forward, the pretreated biomass may stay in the reaction atmosphere for a long time, which may form in the long run hard, condensated, and carbonized material, for example buildups onto the surface of the conveyor screw. The conveyor screw may be blocked out and production have to be stopped for cleaning regularly.

However, when coating and/or polishing at least part of the conveyor screw and/or an inner shell surface of the conveyor, even at high temperatures the buildups may not be formed, which may extend cleaning intervals and reduce production interruptions.

According to an embodiment of the first aspect, at least part of an outer screw surface of the at least one conveyor screw and/or at least part of an inner shell surface of the cylindrical shell may be configured to be coated with the coating material having electrical charge. This way the coating material may repel the pretreated biomaterial and may prevent it from stuck to the surface of the conveyor screw and/or the cylindrical shell.

According to an embodiment of the first aspect, the coating material having electrical charge may be a positively surface charged material or negatively surface charged material. When the pretreated biomaterial and the coating material have the same electrical charge they may repel each other. They both may have positive or negative charge.

According to an embodiment of the first aspect, at least part of an outer screw surface of the at least one conveyor screw and/or at least part of an inner shell surface of the cylindrical shell may be configured to be coated with a coating material having low adhesion tendency. This kind of coating material may prevent the buildups to stick on surfaces.

According to an embodiment of the first aspect, the coating material having low adhesion tendency is polymer, ceramic, enamel, or glass. Different coating materials may be used for coating.

According to an embodiment of the first aspect, polymer may be configured to be selected from a family of fluoropolymers or polyaryletherketones (PAEK).

According to an embodiment of the first aspect, fluoropolymer is polytetrafluoroethylene (PTFE) or perfluoroalkoxy alkane (PFA).

According to an embodiment of the first aspect, fluoropolymer may comprise electrically conductive material. The electrically conductive material may be conductive filler, for example, conductive carbon material.

According to an embodiment of the first aspect, Plasma-technology or dip-coating may be configured to be used for coating. These technologies may be efficient to coat the conveyor screws.

According to an embodiment of the first aspect, a roughness value (Ra) of the at least partly polished outer screw surface of the at least one conveyor screw and/or the at least partly polished inner shell surface of the cylindrical shell may be less than 0,05 microns. With low roughness values smooth and even surfaces may prevent the buildups to stick on them.

According to an embodiment of the first aspect, the conveyor may be a hemihydrolysis reactor or may be configured to be at least partly located inside the hemihydrolysis reactor. The hemihydrolysis reactor may operate in high temperatures, for example between 120 °C to 250 °C. At high temperatures it may be beneficial to use coating and/or polishing of the conveyors to prevent forming of the buildups inside the conveyor and to ensure that the pretreated biomass may be removed effectively out of the reactor.

According to an embodiment of the first aspect, the at least one conveyor screw may be a shafted conveyor screw or a shaftless spiral. Different conveyor screws may be coated or polished.

According to an embodiment of the first aspect, the shafted conveyor screw may comprise a shaft and at least one helical flight extending from the shaft; and an outer shaft surface of the shaft and/or a flight back side of the at least one helical flight may be configured to be at least partly coated or polished. Only those parts that may collect the most buildups may be coated. Those parts with most friction, for example, flight outer ends may stay clean and they may not need coating or polishing.

According to an embodiment of the first aspect, the at least one shafted conveyor screw or the at least one shaftless spiral may be configured to be cooled or warmed. Also, the cooled or warmed conveyor screws may be coated and/or polished. Cooling or warming may form condensate layer on the surfaces to help cleaning.

According to an embodiment of the first aspect, a temperature of at least part of the outer screw surface of the at least one cooled or warmed shafted conveyor screw or the at least one cooled or warmed shaftless spiral conveyor screw may be configured to be kept below a dew point of a surrounding atmosphere of the at least one shafted conveyor screw or the at least one shaftless spiral inside the cylindrical shell. When the temperature is configured to be kept below the dew point of the surrounding atmosphere, a condensate layer may be formed on the outer screw surface. The condensate layer may prevent sticky particles of the pretreated biomass to stick on the outer screw surface, therefore it may keep the surface clean and may also make cleaning easier.

According to an embodiment of the first aspect, the cooled or warmed shafted conveyor screw may comprise a shaft, which is hollow, wherein the cooled or warmed shafted conveyor screw may be configured to receive heat transfer medium within the hollow shaft to cool or warm at least the outer screw surface of the hollow shaft that contacts the pretreated biomass during operation; or the cooled or warmed shaftless spiral may comprise a channel configured to receive the heat transfer medium within the channel to cool or warm the outer screw surface of the shaftless spiral. The hollow shaft or channel may allow the heat transfer medium to be placed inside the conveyor screw to cool or warm the pretreated biomass and/or the atmosphere.

According to an embodiment of the first aspect, the cylindrical shell may comprise at least one nozzle configured to spray liquid or gas to the at least one shaftless spiral. The nozzle may be used to clean the shaftless spiral and/or the cylindrical shell from the buildups; and/or to prevent the buildups to stick on them. Also, the cooled or warmed coated and/or polished conveyor screws may be cleaned with the nozzle.

According to a second aspect, a system comprising a hemihydrolysis reactor comprising a vessel and at least one conveyor according to any one of the first aspects above is disclosed. The at least one conveyor may be configured to be located at least partly inside the hemihydrolysis reactor vessel. The hemihydrolysis reactor may use high temperatures, in which case it may be beneficial to use coated or polished conveyor screw(s) and/or conveyor shell to prevent build-up forming inside the conveyor.

According to a third aspect, use of the at least one conveyor according to any one of the first aspects above for moving pretreated biomass is disclosed.

According to a fourth aspect a method for moving pretreated biomass is disclosed. The conveyor may comprise: a cylindrical shell that may comprise an inlet and an outlet; and at least one conveyor screw that may be rotatably positioned in the cylindrical shell. A temperature inside the cylindrical shell may be from 120 °C to 250 °C. The method may comprise receiving the pretreated biomass from the inlet; moving, by the at least one conveyor screw, the pretreated biomass from the inlet to the outlet; and passing the pretreated biomass out of the cylindrical shell through the outlet. When using the coated and/or polished conveyor screw(s) and/or conveyor shell, even in high temperatures, the buildups may not be formed, which may extend cleaning intervals and reduce production interruptions.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 shows schematically an example of a system according to an embodiment;

FIG. 2 shows schematically an example of a conveyor comprising a shafted conveyor screw according to an embodiment;

FIG. 3 shows schematically an example of the conveyor comprising a cooled or warmed shafted conveyor screw according to an embodiment;

FIG. 4 shows schematically an example of the conveyor comprising a shaftless spiral according to an embodiment;

FIG. 5 shows schematically an example of the conveyor comprising a cooled or warmed shaftless spiral according to an embodiment; and

FIG. 6 shows an example method according to an embodiment.

Like references are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps or operations for constructing and operating the example. However, the same or equivalent functions and sequences may be accomplished by different examples.

One or more conveyors may be located inside a hydrolysis reactor. The conveyor may transfer pretreated biomass out of the hydrolysis reactor. The conveyor may comprise a shafted conveyor screw to move the pretreated biomass from a conveyor inlet to a conveyor outlet. However, especially in high temperature conditions buildups may be formed on a surface of the shafted conveyor screw which may require regular cleaning.

The shafted conveyor screw may be arranged at the bottom of a hydrolysis reactor to transfer the pretreated biomass. Since the temperature of the transferred pretreated biomass is high, buildups on the shafted conveyor screw may affect its efficient operation and may even block the screw and the outlet of the conveyor. Clean keeping of the shafted conveyor screw at high temperatures may be very challenging. Typically buildups may be formed onto the surface of the hydrolysis reactor and the shafted conveyor screw at a temperature range 120 °C to 250 °C. If the pretreated biomass becomes sticky at a certain point of a process, and if a pretreated biomass stream is not moving forward, the pretreated biomass may stay in the reaction atmosphere for a long time and may form in a long run hard buildups, which is, for example, carbonized material, onto the surface of the shafted conveyor screw. This may cause the shafted conveyor screw to be totally blocked, and the hydrolysis reactor may have to be stopped for cleaning regularly. The buildups may also be seen inside of the hydrolysis reactor both on certain locations of a hydrolysis reactor chamber wall, and on the shaft and flights of the shafted conveyor screw.

In this specification and claims a reactor may be a pretreatment reactor, a steam explosion reactor, hydrothermal treatment reactor, or a hemihydrolysis reactor.

In this specification and claims the term pretreated biomass refers to biomass particles and/or lignocellulose particles. Preferably the composition of the pretreated biomass is a mixture of of wood particles, lignocellulose, solid lignin, soluble lignin, carbohydrates, extractives, soluble sugar monomers, and sugar oligomers.

According to an embodiment, the pretreated biomass may be pretreated wood biomass. The pretreated wood biomass may be formed in a process where wood chips may be treated by impregnation followed by hemihydrolysis in the hemihydrolysis reactor using high temperature, steam, and pressure. The wood chips may be hardwood chips, such as beech, birch, ash, oak, maple, chestnut, willow, or poplar chips. The wood chips may also be any combination or mixture of these. The impregnation may be accomplished by treating the wood chips with an impregnation liquid. The impregnation liquid may be water or acidic liquid. Preferably the impregnation liquid is sulfuric acid. The impregnated wood chips may be transferred to hemihydrolysis reactor where the wood chips may be subjected to hemihydrolysis reaction. The hemihydrolysis reaction may be carried out by treating the impregnated wood chips with high temperature steam. The temperature in the hemihydrolysis reactor may be from 120 °C to 250 °C, and the pressure may be 1-20 bar or 2-16 bar, for example. Temperature of the pretreated biomass in the hemihydrolysis reactor is, for example, 120 °C to 250 °C. More preferably temperature of the pretreated biomass in the hemihydrolysis reactor is, for example, 150 °C to 220 °C or 185 °C to 195 °C. Finally the pretreated wood biomass may be transferred out of the hemihydrolysis reactor by the at least one conveyor to be treated further by steam explosion so that fibers may be separated.

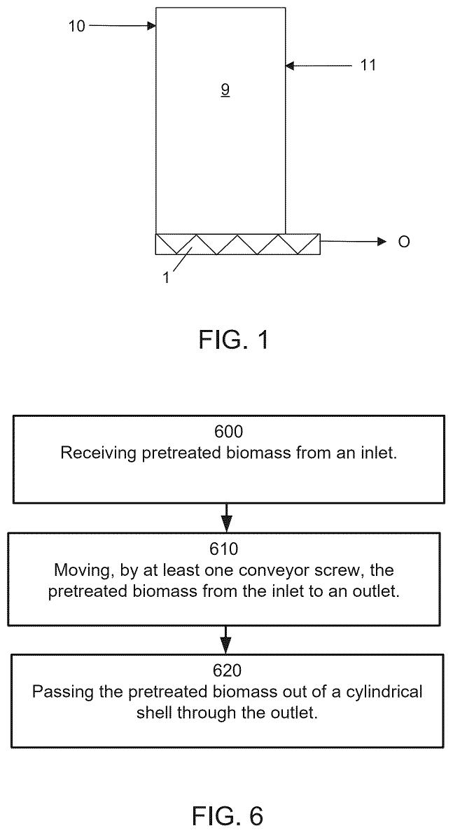

An example of FIG. 1 shows schematically a system comprising a hemihydrolysis reactor comprising a hemihydrolysis reactor vessel 9 and at least one conveyor 1. The at least one conveyor 1 may be located at least partly inside the hemihydrolysis reactor vessel 9. Hemihydrolysis reaction started in the hemihydrolysis reactor vessel 9 may continue also in the at least one conveyor 1. The hemihydrolysis reactor is an area where conditions for hemihydrolysis reaction may be present. In the system the hemihydrolysis reaction may happen inside the hemihydrolysis reactor, which means inside the hemihydrolysis reactor vessel 9 and/or inside the at least one conveyor. In the other words, the hemihydrolysis reaction conditions of the hemihydrolysis vessel 9 may be prevailed in the conveyor 1. The hemihydrolysis reaction may require high temperatures, for example, 120 °C-250 °C, preferably 150 °C-220 °C, more preferably 185 °C-195 °C. In addition to the high temperature, the hemihydrolysis reaction may require steam, and pressure of 1-20 bar or 2-16 bar, for example. Saturated steam pressure may correspond a saturated steam temperature inside the reactor.

The term “hemihydrolysis” may refer to a treatment in which the impregnated and/or pretreated biomass is treated in a reactor, for example a hemihydrolysis reactor with steam having a temperature of 120 °C 250 °C, 150 °C-220 °C, or 185 °C-195 °C. The purpose of the treatment is to degrade and solubilize the hemicellulose contained in the biomass and to break down the biomass structure so that the cellulose may get accessible for enzymes (cellulases) and may be converted to glucose in high yields in the next treatment step after the hemihydrolisis.

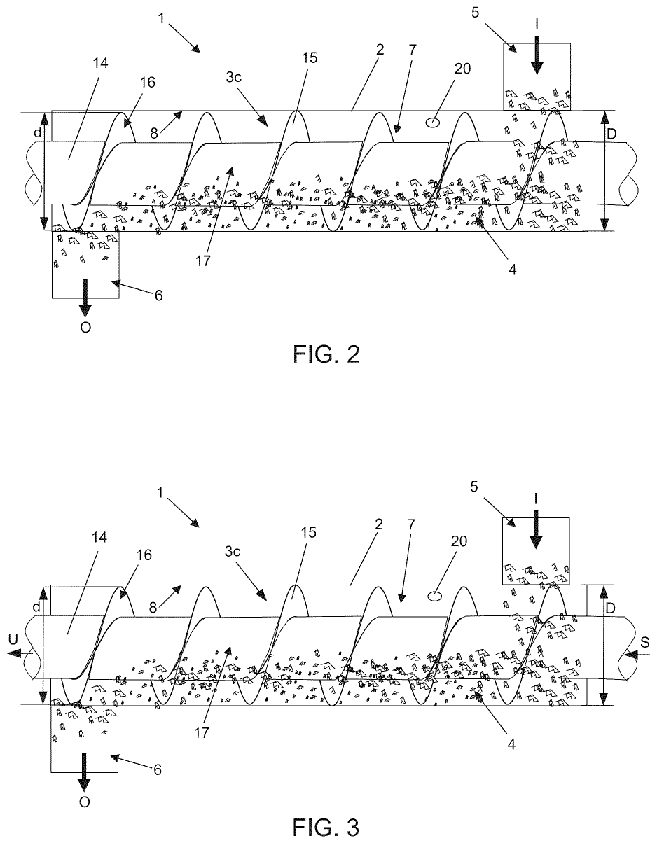

The conveyor 1 may comprise a cylindrical shell 2 and a conveyor screw 3a, 3b, 3c, 3d according to examples of FIGS. 2 to 5. According to an embodiment, the conveyor 1 is a hemihydrolysis reactor or is configured to be located inside the hemihydrolysis reactor. When the at least one conveyor 1 is located at least partly inside the hemihydrolysis reactor, conditions for hemihydrolysis may be present also in the at least one conveyor 1. Thus the at least one conveyor 1 may operate in the hemihydrolysis reaction conditions, at a temperature from 120 °C to 250 °C.

The at least one conveyor 1 may be configured to be located at a bottom part of the hemihydrolysis reactor vessel 9. The at least one conveyor 1 may be configured to be located at least partly inside the hemihydrolysis reactor vessel 9. The system may comprise a plurality of conveyors 1, which may or may not be the same type of conveyors. Pretreated biomass 4 may be fed into the hydrolysis reactor vessel 9 according to arrow 10 and treated with high temperature, added steam (according to arrow 11), and pressure. A temperature inside the cylindrical shell 2 and/or in the hydrolysis reactor vessel 9 is, for example, from 120 °C to 250 °C. More preferably the temperature inside the cylindrical shell and/or the hydrolysis reactor vessel 9 is, for example, from 150 °C to 220 °C. After the hydrolysis, the hydrolyzed pretreated biomass 4 may be removed by the at least one conveyor 1 from the material outlet 6 according to arrow O.

According to an embodiment, composition of the pretreated biomass 4 in the hemihydrolysis reactor vessel 9 and/or in the at least one conveyor 1 comprises biomass particles and/or lignocellulose particles. Preferably the composition of the pretreated biomass is a mixture of wood particles, lignocellulose, solid lignin, soluble lignin fragments, carbohydrates, extractives, soluble sugar monomers, and sugar oligomers. The pretreated biomass may comprise bigger particles, for example, cooked and crushed wood particles and soluble components.

The at least one conveyor 1 according to FIGS. 2 to 5 may be used to remove the pretreated biomass 4 from the hydrolysis reactor 9 of FIG. 1.

While the conveyor 1 in FIG. 1 illustrates only one conveyor screw 3a, 3b, 3c, 3d within the cylindrical shell 2, the number of the conveyor screws 3a, 3b, 3c, 3d within the cylindrical shell 2 should not be considered limiting on the current disclosure. For example, in some examples, multiple conveyor screws 3a, 3b, 3c, 3d may be provided within the cylindrical shell 2.

According to an embodiment, the at least one conveyor screw 3a, 3b, 3c, 3d located inside the cylindrical shell 2 has about the same or smaller approximate outer screw diameter d as an inner shell diameter D of the cylindrical shell 2. A flight distance F between the outer screw surface 7 of the at least one conveyor screw 3a, 3b, 3c, 3d and an inner shell surface 8 of the cylindrical shell 2 is from 0, 1 mm to 5 mm, for example. The flight distance F=(D−d)/2. The flight distance F may be the shortest distance between the outer screw surface 7 and the inner shell surface 8. Also, when the conveyor screw 3a, 3b, 3c, 3d has about the same or close the same approximate outer screw diameter d as the inner shell diameter D, there may be a friction between the inner shell surface 8 and the outer screw surface 7, which friction may keep the inner shell surface 8 and/or the outer crew surface 7 at least partly clean so that no additional cleaning may be needed for the inner shell surface 8 and/or at least part of the outer screw surface 7.

According to an embodiment, the outer screw diameter d of the at least one conveyor screw 3a, 3b, 3c, 3d is larger than a particle size of the pretreated biomass 4. This may allow conveyor 1 to move the biomass 4 effectively. A wood chip particle inside the hydrolysis reactor may have particle size, wherein the length is from 10 mm to 40 mm, thickness is from 2 mm to 15 mm, and width from 10 mm to 30 mm, for example.

According to an embodiment, a conveyor 1 for pretreated biomass 4 is disclosed. The conveyor 1 may comprising a cylindrical shell 2 comprising an inlet 5 for receiving the pretreated biomass 4 and an outlet 6 whereat pretreated biomass 4 passes out of the cylindrical shell 2. The conveyor 1 may further comprise at least one conveyor screw 3a, 3b, 3c, 3d rotatably positioned in the cylindrical shell 2 to move the pretreated biomass 4 out of the cylindrical shell 2. A temperature of the pretreated biomass 4 within the cylindrical shell is, for example, from 120 °C to 250 °C. More preferably the temperature inside the cylindrical shell is, for example, from 150 °C to 220 °C. The at least one conveyor screw 3a, 3b, 3c, 3d and/or the cylindrical shell 2 may be configured to be at least partly coated with a coating material and/or at least partly polished.

It may be possible to coat at least part of the conveyor screw 3a, 3b, 3c, 3d with a coating material and polish at least part of the inner shell surface 8 or vice versa. It may also be possible that at least part of the conveyor screw 3a, 3b, 3c, 3d may be coated with the coating material. For example, at least one flight back side 16 may be coated with the coating material, and rest of the conveyor screw 3a, 3b, 3c, 3d may be polished or leaved without coating or polishing. According to an embodiment, the at least one conveyor screw 3a, 3b, 3c, 3d is configured to be coated with coating material and/or polished at least partly around the outer screw surface 7 of the at least one conveyor screw 3a, 3b, 3c, 3d.

According to an embodiment, at least part of an outer screw surface 7 of the at least one conveyor screw 3a, 3b, 3c, 3d and/or at least part of an inner shell surface 8 of the cylindrical shell 2 is configured to be coated with the coating material having electrical charge. The coating material having electrical charge may be a positively surface charged material or negatively surface charged material. According to an embodiment, the coating material having electrical charge is polymer.

According to an embodiment, at least part of the outer screw surface 7 of the at least one conveyor screw 3a, 3b, 3c, 3d and/or at least part of the inner shell surface 8 of the cylindrical shell 2 is configured to be coated with the coating material having low adhesion tendency. With a term “low adhesion tendency” is meant ability that prevents the buildups to stick on the surface of the shaftless spiral 3, 3b and/or the cylindrical shell 2. This kind of coating material may have low adsorption ability. The coating material having low adhesion tendency may be polymer, ceramic, enamel, or glass. Polymer may be configured to be selected from a family of fluoropolymers or polyaryletherketones (PAEK). Fluoropolymer is, for example, polytetrafluoroethylene (PTFE) or perfluoroalkoxy alkane (PFA).

According to an embodiment, fluoropolymer comprises electrically conductive material. The electrically conductive material may be conductive filler, for example, conductive carbon material.

According to an embodiment, Plasma-technology or dip-coating is configured to be used for coating.

According to an embodiment, the at least one conveyor screw 3a, 3b, 3c, 3d and/or the cylindrical shell 2 may be configured to be at least partly coated with the coating material and/or polished. Coating or polishing may be done all around or at least partly around the at least one conveyor screw 3a, 3b, 3c, 3d and/or inside the conveyor shell 2. When at least part of the outer screw surface 7 and/or the inner shell surface 8 is polished a roughness value Ra of the outer screw surface 7 and/or the inner shell surface 8 may be extremely low, for example, like a surface of a mirror. The Ra value of the outer screw surface 7 and/or the inner shell surface 8 is, for example, less than 1, 6 microns, preferably less than 0, 1 microns, or more preferably less than 0,05 microns. The term “Ra value” should in this specification, unless otherwise stated, be understood as an average roughness of a surface. Ra is an arithmetic average value of a deviation of a trace above and below a center line. Standard SFS-EN 10049:2013 provides more details for measuring the Ra value.

According to an embodiment, a residence time of the pretreated biomass 4 in the hemihydrolysis reactor vessel 9 and in the at least one conveyor 1 is from 1 second to 120 minutes. More preferably the residence time is from 1 second to 30 minutes. When the at least one conveyor 1 is the hemihydrolysis reactor, the residence time of the pretreated biomass 4 in the at least one conveyor 1 is from 1 second to 120 minutes. More preferably the residence time is from 1 second to 30 minutes. The term “residence time” should in this specification, unless otherwise stated, be understood as the time between the pretreated biomass being introduced into or entering the hydrolysis reactor vessel 9 and/or at least one conveyor 1, and the pretreated biomass 4 exited or discharged from the at least one conveyor 1. If there are more than one conveyor 1, the exiting or discharging is from the latest conveyor 1.

According to an embodiment, the cylindrical shell 2 comprises at least one nozzle 20 configured to spray liquid to the at least one conveyor screw 3a, 3b, 3c, 3d, 3b. Spraying may be done with high pressure liquid or gas. The liquid may be water. Water may comprise chemicals, for example, sodium hydroxide. The gas may be steam, for example, water steam. The nozzles 20 may be located at various locations along the inner shell surface 8. The at least one nozzle 20 may be configured to inject gas or liquid inside the conveyor 1 towards the at least one conveyor screw 3a, 3b, 3c, 3d. The at least one sprayer may be configured to clean the conveyor screw 3a, 3b, 3c, 3d and/or the inner shell surface 8 from the buildups. The at least one sprayer may also prevent the buildups to stick on the outer screw surface 7 and/or on the inner shell surface 8. The nozzle 20 may also be used with the at least one conveyor screw 3a, 3b, 3c, 3d, 3b, wherein the at least one conveyor screw 3a, 3b, 3c, 3d, 3b and/or the inner shell surface 8 is configured to be at least partly coated and/or polished.

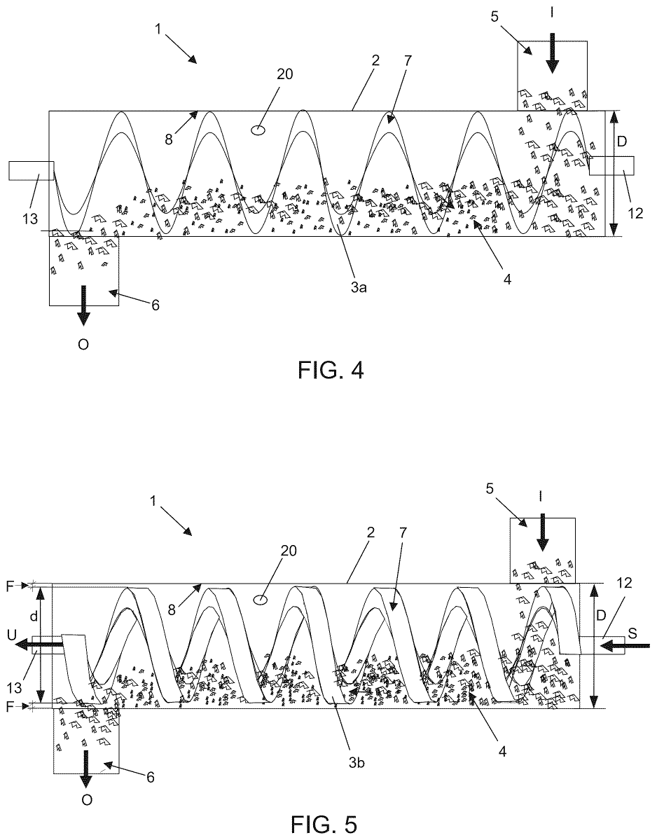

According to an embodiment, the at least one conveyor screw 3a, 3b, 3c, 3d is a shafted conveyor screw 3c, 3d or a shaftless spiral 3a, 3b. FIGS. 2 and 3 show examples of the shafted conveyor screws 3c, 3d and FIGS. 4 and 5 show examples of the shaftless spirals 3a, 3b.

According to an embodiment, the at least one shaftless spiral 3a, 3b has a rectangular, triangle, half-circle, D-shaped, oval, or round cross-section.

An example of FIG. 2 shows schematically a conveyor 1 comprising a shafted conveyor screw 3c. The conveyor 1 may comprise a cylindrical shell 2 comprising an inlet 5 for receiving the pretreated biomass 4 from a bottom of the hemihydrolysis reactor 9, another process, or an outlet of another conveyor. The conveyor 1 may be hemihydrolysis reactor itself. In that situation, the hemihydrolysis reaction may happen in the at least one conveyor 1 and no separate hydrolysis reactor vessel 9 is needed. The cylindrical shell 2 may also comprise and an outlet 6 whereat pretreated biomass 4 passes out of the cylindrical shell 2. Entering the pretreated biomass 4 is shown with an arrow I and passing out of the pretreated biomass 4 is shown with an arrow O. The conveyor 1 may further comprise at least one shafted conveyor screw 3c rotatably positioned in the cylindrical shell 2 to move the pretreated biomass 4 out of the cylindrical shell 2. The shafted conveyor screw 3c may comprise a shaft 14 and at least one helical flight 15 extending from the shaft 14. The shafted conveyor screw 3c may have an outer screw surface 7, which may comprise the outer shaft surface 17 and an outer flight surface. The at least one helical flight 15 may have a flight back side 16 and front side. The flight back side 16 may face towards the inlet 5 of the shafted conveyor screw 3c. The at least one shafted conveyor screw 3c may rotate within the the cylindrical shell 2 to move the pretreated biomass 4 within the cylindrical shell 2 from the inlet 5 to outlet 6. The shafted conveyor screw 3c may have an outer screw diameter d. The cylindrical shell 2 may have an inner shell surface 8 and an inner shell diameter D. When the shafted conveyor screw 3c is used sticky products may adhere most on the shafted conveyor screw 3c at the location where the flight 15 meets the shaft 14, on the flight back side 16, and on the shaft 14.

According to an embodiment, the outer shaft surface 17 of the shaft 14 and/or the flight back side 16 of the at least one helical flight 15 is configured to be at least partly coated with the coating material and/or at least partly polished. The coating and/or polishing may help to clean the shafted conveyor screw 3c, 3d and/or help to keep it clean by preventing the buildups to stick on these surfaces where it is formed most.

FIG. 3 show an example of the cooled or heated shafted conveyor screw 3d and FIG. 5 shows an example of the cooled or heated shaftless spiral 3b.

According to an embodiment, the at least one shafted conveyor screw 3d or the at least one shaftless spiral 3b is configured to be cooled or warmed. Heat transfer medium may be used for cooling or warming. The heat transfer medium may comprise coolant or heat agent. According to an embodiment, the heat transfer medium is liquid or gas. The coolant or the heat agent may be at least one of the following: air, steam, water, oil glycol, and/or medium standing temperature range of 0 °C to 250 °C.

According to an embodiment, a temperature of at least part of the outer screw surface 7 of the at least one cooled or warmed shafted conveyor screw 3d or the at least one cooled or warmed shaftless spiral 3b is configured to be kept below a dew point of a surrounding atmosphere of the at least one shafted conveyor screw 3d or the at least one shaftless spiral 3b inside the cylindrical shell 2. The temperature of the outer screw surface 7 is, for example, from 0,1 to 20 °C below the dew point of the surrounding atmosphere. Preferably, the temperature is from 0,1 to 2 °C below the dew point. It may be beneficial to minimize temperature difference between the outer screw surface 7 and the atmosphere to save energy. Also, the pretreated biomass 4 may have to be kept hot in the reactor.

The atmosphere may be a space inside the inner shell surface 8. The atmosphere may comprise steam inside the conveyor shell 2. The steam may be saturated steam. The steam may be formed from water. The steam may have 100% relative moisture content. The steam that exists at the same temperature as the liquid from which it is formed is known as the saturated steam. When the at least one cooled or warmed container screw 3b, 3d is kept below the dew point of the surrounding atmosphere, cooling or warming may form a condensate layer on the outer screw surface 7 of the at least one shafted conveyor screw 3d or shaftless spiral 3b. The condensate layer may prevent sticky particles of the pretreated biomass 4 to stick on the outer screw surface 7 and make cleaning easier.

An example of FIG. 3 shows schematically a conveyor 1 comprising a cooled or warmed shafted conveyor screw 3d. The conveyor 1 of FIG. 3 may be the same as in FIG. 2 expect the shafted conveyor screw 3d comprises a hollow shaft 14 for cooling or warming.

According to an embodiment, the cooled or warmed shafted conveyor screw 3d comprises a shaft 14, which is hollow, and wherein the shafted conveyor screw 3d is configured to receive the coolant or heat agent within the hollow shaft 14 to cool or warm the outer screw surface 7 of the hollow shaft 14 that contacts the pretreated biomass 4 during operation. The hollow part of the shaft may be a channel. The shafted conveyor screw 3d may be internally cooled with the coolant or warmed with the heat agent. As the coolant flows through the hollow shaft of the shafted conveyor screw 3d, the temperature of the coolant may increase due to contact of the cooled shafted conveyor screw 3d with the pretreated biomass 4. As the heat agent flows through the hollow shaft of the shafted conveyor screw 3d, the temperature of the heat agent may decrease due to contact of the shafted conveyor screw 3d with the pretreated biomass 4. The coolant or the heat agent may be directed inside the hollow shaft 14 or inside the channel of the shafted conveyor screw 3d as indicated by arrow S and out of the hollow shaft 14 or the channel as indicated by arrow U. The heat transfer medium and the pretreated biomass 4 may move in the same direction inside the conveyor 1.

An example of FIG. 4 shows schematically a conveyor 1 comprising a shaftless spiral 3a. The conveyor 1 may comprise a cylindrical shell 2 comprising an inlet 5 for receiving the pretreated biomass 4. The conveyor 1 may receive the pretreated biomass 4 from the bottom of the hemihydrolysis reactor 9, an outlet 6 of another conveyor 1, or from another process. The conveyor 1 may be hemihydrolysis reactor itself. In that situation, the hemihydrolysis reaction may happen in the at least one conveyor 1 and no separate hydrolysis reactor vessel 9 is needed. The cylindrical shell 2 may also comprise an outlet 6 whereat pretreated biomass 4 may pass out of the cylindrical shell 2. Entering and passing out of the pretreated biomass 4 are shown with arrows I and O. The conveyor 1 may further comprise at least one shaftless spiral 3a rotatably positioned in the cylindrical shell 2 to move the pretreated biomass 4 out of the cylindrical shell 2. The shaftless spiral 3a does not have any shaft, wherein the pretreated biomass 4 could stick. The inlet support member 12 supports the shaftless spiral 3a from an inlet part and an outlet support member 13 supports the shaftless spiral 3a from an outlet part allowing it to rotate. The at least one shaftless spiral 3a may rotate within the the cylindrical shell 2 to move the pretreated biomass 4 within the cylindrical shell 2 from the inlet 5 to the outlet 6. The shaftless spiral 3a may have the outer screw surface 7 and the outer spring diameter d. The outer screw surface 7 may comprises all the sides of the shaftless spiral 3, 3b or is a jacket around the shaftless spiral 3, 3b. The cylindrical shell may have an inner shell surface 8 and the inner shell diameter D.

While the conveyor 1 in FIG. 1 illustrates only one conveyor screw 3a, 3b, 3c, 3d within the cylindrical shell 2, the number of the conveyor screw 3a, 3b, 3c, 3d in FIGS. 2 to 5 within the cylindrical shell 2 should not be considered limiting on the current disclosure. For example, in some examples, multiple conveyor screws 3a, 3b, 3c, 3d may be provided within the cylindrical shell 2. When the conveyor has more than one conveyor screw 3a, 3b, 3c, 3d, they may clean each other.

An example of FIG. 5 shows schematically a conveyor 1 comprising a shaftless spiral 3b. The conveyor 1 of FIG. 5 may be the same as in FIG. 4 expect the shaftless spiral 3b may comprise a channel. Also, an inlet support member 12 and an outlet support member 13 may be hollow to allow a heat transfer medium to enter through the inlet support member 12 to the channel of the shaftless spiral 3b and leave the channel through the outlet support member 13.

According to an embodiment, the at least one shaftless spiral is hollow. The hollow shaftless spiral 3b may allow heat transfer medium to be placed inside the hollow shaftless spiral 3b. It may also lighten the structure. The shaftless spiral 3b may be internally cooled with a coolant and/or warmed with heat agent. The conveyor 1 comprising the at least one shaftless spiral 3b may may be used in hemidydrolysis reactor of FIG. 1 or alone as a hydrolysis reactor.

According to an embodiment, the shaftless spiral 3b comprises a channel configured to receive the heat transfer medium within the channel to cool or warm an outer screw surface 7 of the shaftless spiral 3b. A hollow part of the shaftless spiral 3b may be the channel. The channel may be formed inside the shaftless spiral 3b. The outer screw surface 7 of the shaftless spiral 3b may contact the pretreated biomass 4. The shaftless spiral 3b may allow the heat transfer medium to be placed inside the channel to cool or warm the outer screw surface 7 of the shaftless spiral 3b inside the cylindrical sell 2. As the coolant flows through the shaftless spiral 3b, the temperature of the coolant may increase due to contact of the outer screw surface 7 of the shaftless spiral 3b. As the the heat agent flows through the shaftless spiral 3b, the temperature of the heat agent may decrease due to contact of the outer screw surface 7 of the shaftless spiral 3b. The coolant or the heat agent may be directed inside the shaftless spiral 3b as indicated by arrow S and out of the shaftless spiral 3b as indicated by arrow U. The coolant or the heat agent may be directed inside the channel through the hollow inlet support member 12 from an inlet side of the conveyor 1 and out of the channel from the hollow outlet support member 13 from an outlet side of the conveyor 1. The the heat transfer medium and the pretreated biomass 4 may move in the same direction inside the conveyor 1.

According to an embodiment, the at least one conveyor 1 as described above may be used for moving pretreated biomass. The at least one conveyor 1 according to FIGS. 2 to 5 may be used in the system as described in the FIG. 1. The at least one conveyor 1 according to FIGS. 2 to 5 may also be used as a hemihydrolysis reactor or part of the hemihydrolysis reactor.

FIG. 6 illustrates an example of a method for moving pretreated biomass 4 with a conveyor 1, wherein the conveyor 1 comprises a cylindrical shell 2 comprising an inlet 5 and an outlet 6, and at least one conveyor screw 3a, 3b, 3c, 3d rotatably positioned in the cylindrical shell. A temperature of inside the cylindrical shell 2 may be from 120 °C to 250 °C, and the at least one conveyor screw 3a, 3b, 3c, 3d and/or the cylindrical shell 2 may be configured to be at least partly coated with a coating material and/or at least partly polished.

At operation 600, the method may comprise receiving the pretreated biomass 4 from the inlet 5.

At operation 610, the method may comprise moving, by the at least one conveyor screw 3, 3b, 3c, 3d the pretreated biomass 4 from the inlet 5 to the outlet 6.

At operation 620, the method may comprise passing the pretreated biomass 4 out of the cylindrical shell 2 through the outlet 6.

Further features of the method directly result from functionalities of, for example, the conveyor 1. Different variations of the method may be also applied, as described in connection with the various embodiments.

The conveyor 1 may be configured to perform or cause performance of any aspect of the method described herein.

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

Although subjects may be referred to as ‘first, ‘second’, or ‘third’ subjects, this does not necessarily indicate any order or importance of the subjects. Instead, such attributes may be used solely for the purpose of making a difference between subjects.

It will be understood that the above description is given by way of example only and that various modifications may be made by those skilled in the art. The above specification, examples and data provide a complete description of the structure and use of embodiments. Although various embodiments have been described above with a certain degree of particularity, or with reference to one or more individual embodiments, those skilled in the art could make numerous alterations to the disclosed embodiments without departing from scope of this specification.

1. A conveyor for pretreated biomass, wherein the conveyor comprising:
a cylindrical shell comprising an inlet for receiving the pretreated biomass and an outlet whereat the pretreated biomass passes out of the cylindrical shell; and
at least one conveyor screw rotatably positioned in the cylindrical shell to move the pretreated biomass out of the cylindrical shell,
wherein a temperature inside the cylindrical shell is from 120 °C to 250 °C, and
the at least one conveyor screw and/or the cylindrical shell is configured to be at least partly coated with a coating material and/or at least partly polished.

2. The conveyor according to claim 1, wherein at least part of an outer screw surface of the at least one conveyor screw and/or at least part of an inner shell surface of the cylindrical shell is configured to be coated with the coating material having electrical charge.

3. The conveyor according to claim 2, wherein the coating material having electrical charge is a positively surface charged material or negatively surface charged material.

4. The conveyor according to claim 2, wherein the coating material having electrical charge is polymer.

5. The conveyor according to claim 1, wherein the coating material has low adhesion tendency.

6. The conveyor according to claim 5, wherein the coating material having low adhesion tendency is polymer, ceramic, enamel, or glass.

7. The conveyor according to claim 6, wherein polymer is fluoropolymer or polyaryletherketone (PAEK).

8. The conveyor according to claim 7, wherein fluoropolymer is polytetrafluoroethylene (PTFE) or perfluoroalkoxyalkane (PFA).

9. The conveyor according to claim 7, wherein fluoropolymer comprises electrically conductive material.

10. The conveyor according to claim 1, wherein a roughness value (Ra) of the at least partly polished outer screw surface of the at least one conveyor screw and/or the at least partly polished inner shell surface of the cylindrical shell is less than 0,05 microns.

11. The conveyor according to claim 1, wherein the conveyor is a hemihydrolysis reactor or is configured to be at least partly located inside the hemihydrolysis reactor.

12. The conveyor according to claim 1, wherein the at least one conveyor screw is a shafted conveyor screw or a shaftless spiral.

13. The conveyor according to claim 12, wherein
the shafted conveyor screw comprises a shaft and at least one helical flight extending from the shaft; and
an outer shaft surface of the shaft and/or a flight back side of the at least one helical flight is configured to be at least partly coated or polished.

14. The conveyor according to claim 12, wherein the at least one shafted conveyor screw or the at least one shaftless spiral is configured to be cooled or warmed.

15. The conveyor according to claim 14, wherein a temperature of at least part of the outer screw surface of the at least one cooled or warmed shafted conveyor screw or the at least one cooled or warmed shaftless spiral is configured to be kept below a dew point of a surrounding atmosphere of the at least one shafted conveyor screw or the at least one shaftless spiral inside the cylindrical shell.

16. The conveyor according to claim 14,
wherein the cooled or warmed shafted conveyor screw comprises a shaft, which is hollow, and wherein the cooled or warmed shafted conveyor screw is configured to receive a heat transfer medium within the hollow shaft to cool or warm at least the outer screw surface of the hollow shaft that contacts the pretreated biomass during operation, or
the cooled or warmed shaftless spiral comprises a channel configured to receive the heat transfer medium within the channel to cool or warm the outer screw surface of the shaftless spiral.

17. The conveyor according to claim 1, wherein the cylindrical shell comprises at least one nozzle configured to spray liquid or gas to the at least one conveyor screw.

18. A system comprising a hemihydrolysis reactor comprising a vessel and the at least one conveyor according to claim 1, wherein the at least one conveyor is configured to be located at least partly inside the hemihydrolysis reactor vessel.

19. Use of the at least one conveyor according to claim 1 for moving pretreated biomass.

20. A method for moving pretreated biomass with a conveyor, wherein the conveyor includes a cylindrical shell comprising an inlet and an outlet and at least one conveyor screw rotatably positioned in the cylindrical shell, wherein a temperature of inside the cylindrical shell is from 120 °C to 250 °C, and the at least one conveyor screw and/or the cylindrical shell is configured to be at least partly coated with a coating material and/or at least partly polished, the method comprising:
receiving the pretreated biomass from the inlet;
moving, by the at least one conveyor screw, the pretreated biomass from the inlet to the outlet; and
passing the pretreated biomass out of the cylindrical shell through the outlet.
